(19) United States
(12) Patent Application Publication
(10) Pub. No.: US 2011/0271843 A1
(43) Pub. Date: Nov. 10, 2011

(54) EXTRACTING MECHANISM FOR COFFEE CAPSULE

(75) Inventors: Sheng-fang CHENG, Tainan County (TW); Weijun Zhong, Zhangzhou (CN)

(73) Assignee: Tsann Kuen (Zhangzhou) Enterprise Co., Ltd., Fujian Province (CN)

(21) Appl. No.: 13/103,228

(22) Filed: May 9, 2011

(30) Foreign Application Priority Data
May 7, 2010 (CN) 201020182878.9

(51) Int. Cl. A47J 31/40

(52) U.S. Cl. 99/295

(57) ABSTRACT

An extracting mechanism for coffee capsule has a bracket member, a coffee capsule member removably mounted in the cavity of the bracket, and a capsule thrust mechanism mounted on a panel. A handle is fixedly mounted on the top surface of the panel and an extracting plate having an upper thrust needle in the bottom; and a crank sliding mechanism connected between the handle and the extracting plate. When the handle is rotated around the shaft, the crank sliding mechanism will drive the extracting plate to move upwardly or downwardly. When the extracting plate moves downwardly along the track, the upper thrust needle will through the top of the capsule and then the bottom of the capsule will be thrust. The coffee power then can be extracted through the upper and lower thrust needles.

### FIELD OF THE INVENTION

The present invention relates to a household appliances, especially relates to an extracting mechanism for coffee capsule.

### BACKGROUND OF THE INVENTION

Coffee is one of the daily drinks for people, usually coffee is made by coffee maker. The coffee maker can be divided into normal coffee maker and capsule coffee maker. Normal coffee maker can process grinding coffee beans and brew coffee, while capsule coffee maker is to brew coffee in a capsule in which coffee power is contained. Because there is not grinding process, so the capsule coffee maker has advantages such as simple use etc. Usually, a common capsule coffee maker comprises a bracket containing a cup body for putting a coffee capsule inside, in use, the coffee capsule is put into the cup body, then the capsule is thrust to extract coffee. Because the cup body can not be take out from the bracket, thus has the following disadvantages: after use each time, the remnant liquid and residue of coffee will be remained in the cup body, and they are difficult to the be cleaned, which will affect the taste of next cup coffee. If the cleaning is after too long, it may affect the health of users. Additionally, the traditional capsule coffee maker had disadvantages such as complex thrust mechanism

### SUMMARY OF THE INVENTION

The primary object of the invention is to provide an extracting mechanism for coffee capsule having a removable cup to solve the problem of being difficult to clean the cup body in common capsule coffee maker.

The other object of the invention is to provide a capsule thrust mechanism with simple structure.

The objects are achieved by:

an extracting mechanism for coffee capsule comprising:
a bracket member comprising a bracket and a panel on the top of said bracket, said bracket has a cavity for containing coffee capsule member;
a coffee capsule member removably mounted in the cavity of said bracket, said coffee capsule member comprises a cup body for containing capsule and a holder for containing the cup body; the bottom of said cup body has a lower thrust needle, and
a capsule thrust mechanism mounted on said panel comprising:
   a handle fixedly mounted on the top surface of the panel of said bracket member;
   an extracting plate having an upper thrust needle in the bottom; and
   a crank sliding mechanism connected between said handle and said extracting plate.

In a preferred embodiment of the present invention, said crank sliding mechanism comprising at least a lever pass through said panel and pivotally connected on the bottom of the middle of the handle, and at least a connected rod whose upper end pivotally connected to the lower end of said lever, and the lower end of the rod is connected to said extracting plate. The movement of the handle can drive the extracting plate move up and down by the action of the crank sliding mechanism.

In a preferred embodiment of the present invention, each of the two opposite sides of the inner wall of the bracket has a vertical track.

In a preferred embodiment of the present invention, said holder of said coffee capsule member comprises a housing and a seat. Said seat has corresponding shape to the cavity of the bracket.

In a preferred embodiment of the present invention, the cup body of the capsule member comprising a upper cup and a lower cup, said lower cup is sleeved to the bottom of the upper cup, the bottom of the upper cup has a through hole, one end of said lower thrust needle is insert in the through hole and the other end is upwardly inserted in the cavity of the upper cup.

In a preferred embodiment of the present invention, one end of the handle is pivotally connected to said panel, the opposite free end has a pressing sheet, the bottom of the press sheet has a groove, the corresponding position of the panel has a hook, said hook is clipped in the groove.

In a preferred embodiment of the present invention, the top surface of the extracting plate has a pair of upper projections, each projection has a pin hole for pivotally connected to the lower end of the connecting rod, each of the front and rear sides of the extracting plate has a side projection corresponding to the vertical tracks of the inner wall of the bracket, the said side projection can slide along the tracks.

In a preferred embodiment of the present invention, a sealing silicon sheet is mounted between said extracting plate and the upper thrust needle.

In a preferred embodiment of the present invention, both the upper thrust needle and the lower thrust needle are hollow.

A capsule coffee maker comprises above extracting mechanism for coffee capsule.

Compared with the prior art, the present invention has the following advantages: a. the mechanism can be assembled easily, without any bolts, and the mechanism can be assembled separately which is convenient for pre-process, thus the assembly time is shorted and the efficiency is improved. B. simple action, the thrust function can be achieved by rotate the handle only. Press the handle downwardly to make the handle to be rotated around the shaft, the crank sliding mechanism will drive the extracting plate to move upwardly or downwardly. When the extracting plate is moved downwardly along the track, the upper thrust needle will through the top of the capsule and then the bottom of the capsule will be thrust. The coffee power then can be extracted through the upper and lower thrust needles. C. the capsule member can be separated from the hole machine, and cleaned by the dishwasher, this facilitate to the users and is convenient.

### BRIEF DESCRIPTION OF THE DRAWINGS

Preferred embodiment of the present invention will be described in detail with reference to the drawings and examples

FIG. 1 is the exploded view of the present invention.

FIG. 2 is the sectional view of the capsule member of the present invention.

FIG. 3 is the sectional view of the bracket member with the capsule thrust mechanism.

FIG. 4 is the using state of the present invention.

FIG. 5 is the perspective view of the bracket member.

FIG. 6 is the perspective view of the capsule extracting plate.

FIG. 7 is the perspective view of the holder.

FIG. 8 is the exploded view of the handle.

FIG. 9 is the perspective view of the lever.

### PREFERRED EMBODIMENT OF THE INVENTION

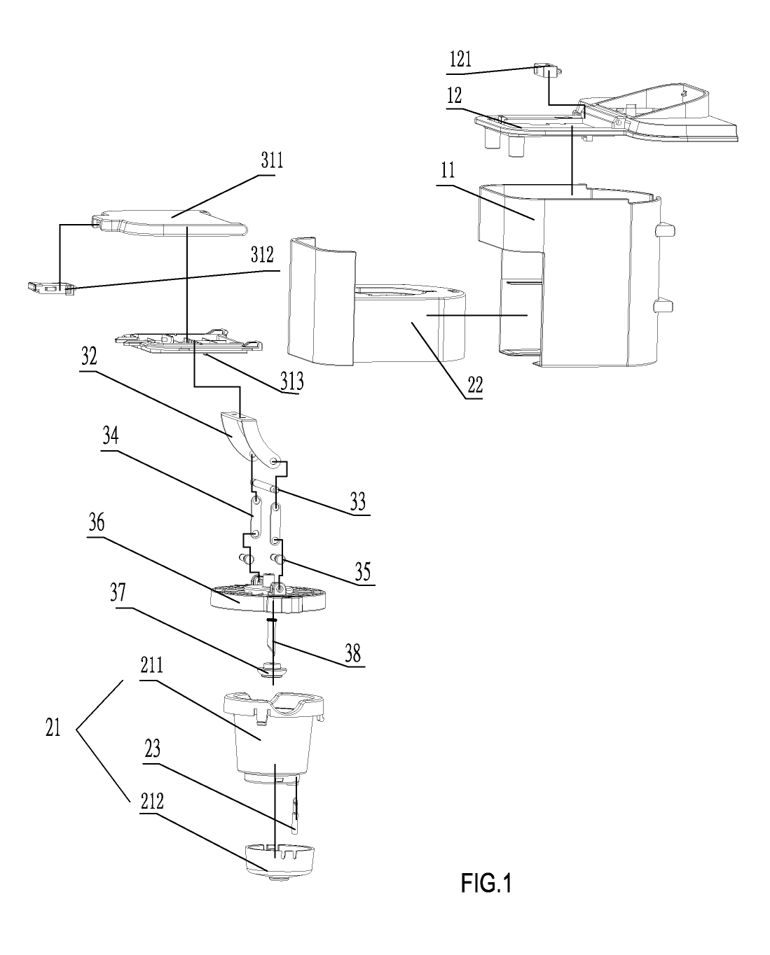

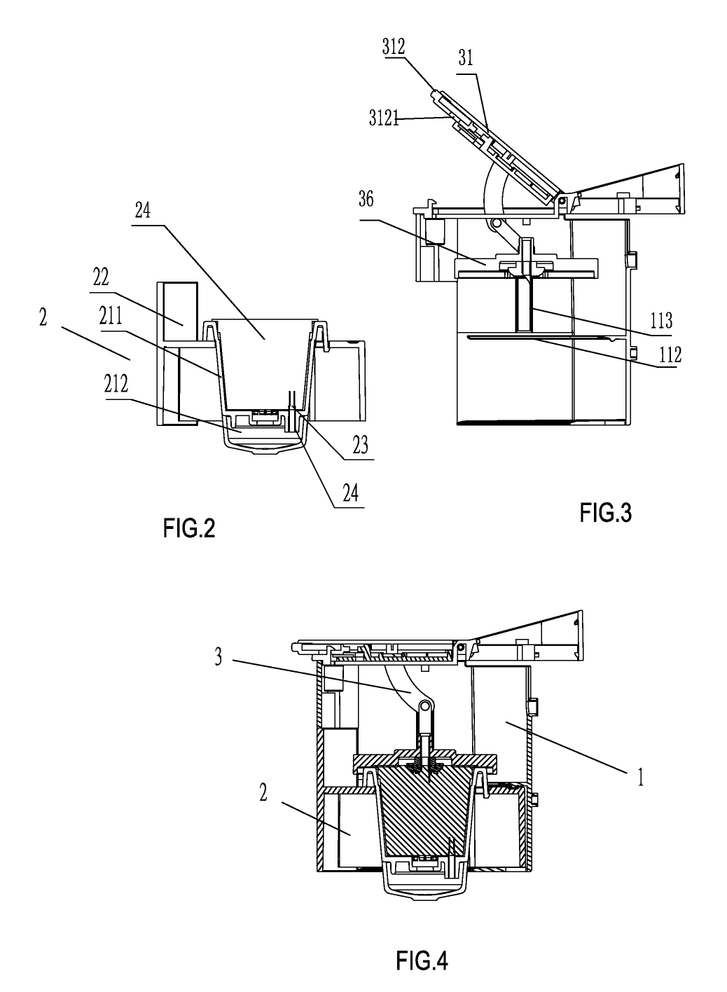

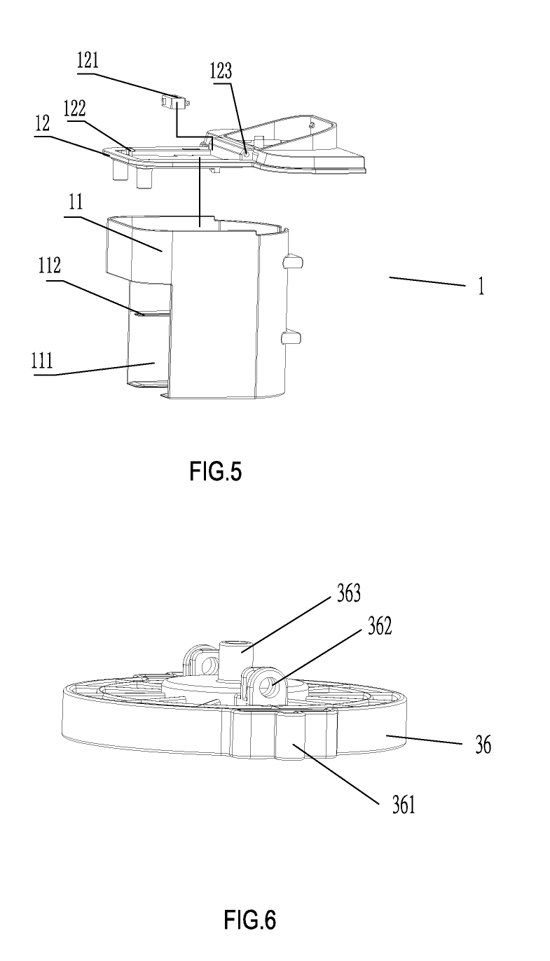

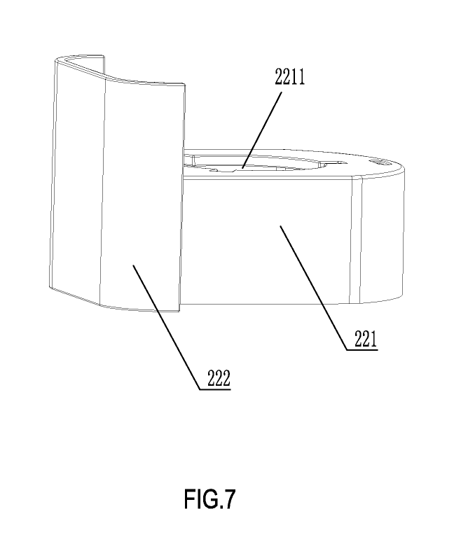

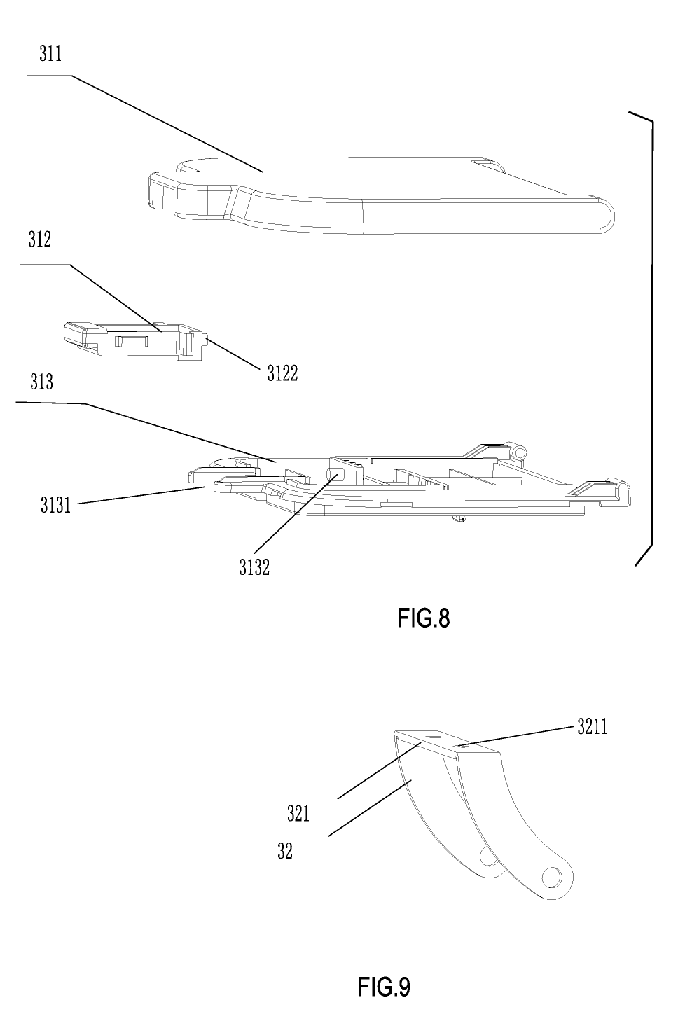

Referring to FIG. 1 to FIG. 5, the extracting mechanism for coffee capsule comprises: a bracket member 1, a capsule member 2 and a capsule thrust mechanism 3.

The bracket member comprises a bracket 11 and a top panel 12 mounted on the top of the bracket 11, the bracket 11 is a shell body comprises a cavity for containing the capsule member inside, one side of the cavity has an opening 111 for the in or out of the capsule member. A transversal baffle plate 112 is formed around the middle part of the inner wall of the shell, which is formed by the inner wall being extended to the inside of the cavity, and vertical tracks 113 are formed also, which are grooves each formed by two vertical projections, the position is from the near top to the transversal baffle plate 112. There are two the vertical tracks and they are symmetrically set; a hook 122 is mounted on the left of the top panel 12, a seat 123 and a micro-switch 121 are mounted on the middle of the top panel 12.

The capsule member 2 removably mounted inside the cavity 111 of the bracket comprises a cup body 21 for containing coffee capsule 24 and a holder 22 for containing the cup body 21, the holder 22 comprises a housing 222 and a seat 221, wherein the seat 221 can be removed from or inserted into the cavity via the opening 111 of the cavity, the seat 221 has a chamber 2211 for containing the cup body. The cup body 21 comprises an upper cup 211 and a lower cup 212, the bottom of the upper cup 211 is sleeved in the top of the lower cup 212, one side of the bottom of the upper cup 211 has a through hole 24, in which a hollow lower thrust needle 23 is mounted, the needle 23 is inserted inside the cavity of the upper cup 211.

The capsule thrust mechanism 3 comprises a handle 31 fixedly mounted on the top of the panel of the bracket member; an extracting plate 36 which has a hollow upper thrust needle 38 in the bottom; and a crank sliding mechanism connected between the handle and the extracting plate, which comprises a pair of levers 32 and a pair of connecting rods 34.

The right end of the handle 31 is pivotally connected to the seat 123 of the top panel 12, the other end. i.e. the left end is a movable free end. The handle comprises an upper shell 311, a cover 313 corresponding to the shell 311, and a pressing sheet 312 mounted between the cover 313 and the upper shell 311, the pressing sheet 312 is in the left end of the handle. The bottom of the pressing sheet has a groove 3121 corresponding to hook 122, the hook 122 can fixed to or move away from the groove, thus the handle can be moved away or fixed to the panel. The inner end of the pressing sheet has a column 3122 for fixing a spring, and another column 3132 for fixing spring corresponding to the column 3122 is mounted in the corresponding position of the cover.

There are two lever 32 and they are arc, the upper ends of which are connected together by a connecting sheet 321, the connecting sheet 321 has bolt holes 3211 through which the levers 32 can be locked to bottom of the cover 313. The lower end of the levers 32 are connected to a pair of connecting rods 34 respectively via a pin 33, and the lower ends of the connecting rods 34 are connected to the extracting plate 36 via a pair of pin 35.

Each of the front and rear sides of the extracting plate 36 has a projection 361, which can move along the vertical tracks 113, by the projections 361 the extracting plate 36 can be moved along the vertical tracks 113. The top surface of the extracting plate 36 has two fixing portion 362 for fixing the connecting rods 34; the center of the extracting plate has a needle column 363, where a hollow upper thrust needle 38 is mounted in (referring to FIG. 4 also), a sealing silicon sheet 37 is mounted between the bottom of the needle column and the extracting plate.

In use, press the pressing sheet 32 by hand to let the hook 122 release from the handle 31, then the handle 31 can be moved. Lift the handle 31 up, by the action of the levers 32 and connecting rods 34, the extracting plate 36 is moved up along the tracks 113. Put coffee capsule into the upper cup 211, and then put the hole capsule member 2 into coffee maker, press down the handle 31, the extracting plate 36 is moved down along the tracks 113, the upper thrust needle is thrust into the capsule, then coffee extracting action is processed. After use, the coffee capsule member 2 can be removed from the coffee maker to be cleaned.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with detailed description, but rather by the claims appended hereto.

What is claimed is:

1. An extracting mechanism for coffee capsule comprising:
a bracket member comprising a bracket and a panel on the top of said bracket, said bracket has a cavity for containing coffee capsule member;
a coffee capsule member removably mounted in the cavity of said bracket, said coffee capsule member comprises a cup body for containing capsule and a holder for containing the cup body; the bottom of said cup body has a lower thrust needle, and
a capsule thrust mechanism mounted on said panel comprising:
a handle fixedly mounted on the top surface of the panel of said bracket member;
an extracting plate having an upper thrust needle in the bottom; and
a crank sliding mechanism connected between said handle and said extracting plate.

2. The extracting mechanism for coffee capsule according to claim 1, wherein said crank sliding mechanism comprising at least a lever pass through said panel and pivotally connected on the bottom of the middle of the handle, and at least a connected rod whose upper end pivotally connected to the lower end of said lever, and the lower end of the rod is connected to said extracting plate.

3. The extracting mechanism for coffee capsule according to claim 1, wherein each of the two opposite sides of the inner wall of the bracket has a vertical track.

4. The extracting mechanism for coffee capsule according to claim 1, wherein said holder of said coffee capsule member comprises a housing and a seat.

5. The extracting mechanism for coffee capsule according to claim 1, wherein the cup body of the capsule member comprising an upper cup and a lower cup, said lower cup is sleeved to the bottom of the upper cup, the bottom of the upper cup has a through hole, one end of said lower thrust needle is inserted in the through hole and the other end is upwardly inserted in the cavity of the upper cup.

6. The extracting mechanism for coffee capsule according to claim 1, wherein one end of the handle is pivotally connected to said panel, the opposite free end has a pressing sheet, the bottom of the press sheet has a groove, and the corresponding position of the panel has a hook, said hook is clipped in the groove.

7. The extracting mechanism for coffee capsule according to claim 1, wherein the top surface of the extracting plate has a pair of upper projections, each projection has a pin hole for pivotally connected to the lower end of the connecting rod, each of the front and rear sides of the extracting plate has a side projection corresponding to the vertical tracks of the inner wall of the bracket, said side projection can slide along said tracks.

8. The extracting mechanism for coffee capsule according to claim 1, wherein a sealing silicon sheet is mounted between said extracting plate and said upper thrust needle.

9. The extracting mechanism for coffee capsule according to claim 1, wherein both the upper thrust needle and the lower thrust needle are hollow.

10. A capsule coffee maker comprises extracting mechanism for coffee capsule according to claim 1.
